(19) United States
(12) Patent Application Publication
(10) Pub. No.: US 2025/0353705 A1
(43) Pub. Date: Nov. 20, 2025

(54) ELEVATOR CAR WITH RETRACTABLE APRON AND ELEVATOR SYSTEM COMPRISING SUCH AN ELEVATOR CAR

(71) Applicant: Otis Elevator Company, Farmington, CT (US)

(72) Inventor: Franck Rivoiret, Gien (FR)

(21) Appl. No.: 19/202,389

(22) Filed: May 8, 2025

(30) Foreign Application Priority Data
May 16, 2024 (EP) 24305768.4

(51) Int. Cl. B66B 13/28

(52) U.S. Cl. CPC B66B 13/285

(57) ABSTRACT

An elevator car (6) includes a retractable apron (12), which is movable between an extended position and a retracted position, and a retraction mechanism (14), which is configured for retracting the apron (12) from the extended position into the retracted position when the elevator car (6) approaches the bottom (4a) of a hoistway (4), so that the apron (12) does not contact the bottom (4a) of the hoistway (4).

### FOREIGN PRIORITY

This application claims priority to European Patent Application No. 24305768.4, filed M ay 16, 2024, and all the benefits accruing therefrom under 35 U.S.C. § 119, the contents of which in its entirety are herein incorporated by reference.

### TECHNICAL FIELD OF INVENTION

The invention relates to an elevator car comprising a retractable apron and to an elevator system comprising such an elevator car. The invention further relates to a method of moving the apron of such an elevator car.

### BACKGROUND OF THE INVENTION

An elevator system comprises at least one elevator car configured for traveling along an hoistway between a plurality of landings located at different floors.

The at least one elevator car is usually equipped with an apron extending from a bottom of the at least one elevator car for closing a gap that may be formed between the bottom of the elevator car and the floor of one of the landings, when the bottom of the elevator car is arranged in some distance above the floor of the respective landing.

In case no or only a shallow pit is formed at the bottom of the hoistway, the apron should be retractable. Such an architecture involves that the apron will hit the bottom of the hoistway, when the elevator car is moved to the lowest landing. The apron hitting the bottom of the hoistway may result in undesirable noise and wear of the apron.

It would therefore be beneficial to provide an improved elevator car comprising a retractable apron, which allows preventing the apron from hitting the bottom of the hoistway when no or only a shallow pit is formed at the bottom of the hoistway.

### SUMMARY OF THE INVENTION

According to an exemplary embodiment of the invention, an elevator car comprises a retractable apron, which is movable between an extended position and a retracted position. In the extended position, the apron extends over a first distance from a bottom of the elevator car. In the retracted position, the apron extends over a second distance from the bottom of the elevator car, wherein the second distance is shorter than the first distance. The second distance may be zero, so that the apron does not extend below the bottom of the elevator car, when it is in the retracted position. The elevator car further comprises at least one retraction mechanism, which is configured for retracting the apron from the extended position into the retracted position when the elevator car approaches the bottom of a hoistway, so that the apron does not contact the bottom of the hoistway.

Exemplary embodiments of the invention further include an elevator system comprising a hoistway having a bottom and extending between a plurality of landings; an elevator car according to an exemplary embodiment of the invention, which is configured for traveling along the hoistway between the plurality of landings; and at least one activation member provided in the hoistway. The at least one activation member is configured for interacting with the at least one retraction mechanism of the elevator car for causing the at least one retraction mechanism to retract the apron so that the apron does not contact the bottom of the hoistway, when the elevator car approaches the bottom of the hoistway.

Exemplary embodiments of the invention also include a method of moving the apron of an elevator car in an elevator system according to an exemplary embodiment of the invention, wherein the method includes activating the at least one retraction mechanism of the elevator car in the course of moving the elevator car towards the bottom of the hoistway such as to move the apron from the extended position to the retracted position, avoiding contact between the apron and the bottom of the hoistway.

Exemplary embodiments of the invention allow reliably preventing the apron of the elevator car from touching the bottom of the hoistway when the elevator car approaches the bottom of the hoistway even in an elevator system in which no or only a shallow pit is formed at the bottom of the hoistway. According to exemplary embodiments of the invention, the apron is retracted automatically by the movement of the elevator car, when the elevator car approaches the bottom of the hoistway without the need for human intervention. As a result, noise and damage of the apron, which may be the result of the apron hitting the bottom of the hoistway, may be reliably prevented.

A number of optional features are set out in the following. These features may be realized in particular embodiments, alone or in combination with any of the other features.

The retraction mechanism may be a completely mechanical retraction mechanism, i.e. a retraction mechanism that does not include any electric components. The retraction mechanism may in particular not include a motor. A purely mechanical retraction mechanism is very reliable and may be implemented at low costs. A mechanical retraction mechanism, which does not comprise any electric components, does in particular not need to be coupled to the electric system of the elevator system. In consequence, the installation of the retraction mechanism is less complex than the installation of a retraction mechanism comprising electric components.

Activation of the at least one retraction mechanism may be effected by movement of the elevator car towards the bottom of the hoistway without the need for any further activation signals.

The retraction mechanism may comprise an apron tension member, for example a rope or belt, which is coupled to the apron for moving the apron from the extended position to the retracted position. The apron tension member may be made of metal, such as steel, or a suitable synthetic material. The apron tension member may comprise a first end, which is coupled to the apron, and a second end, which is coupled to the elevator car. An apron tension member provides a reliable element for moving the apron between the extended position and the retracted position.

The retraction mechanism may comprise at least one roller for deflecting the apron tension member. The at least one roller may be a pulley, a drum, or a barrel. The retraction mechanism may in particular comprise two rollers or three rollers. The at least one roller and the apron tension member may be arranged in a configuration, which is adapted to form, in combination with an activation member provided in the hoistway, a block and tackle, in particular a block and tackle including a 1:2 roping.

1:2 roping is, however, not mandatory.In alternative embodiments, it may be a simple 1:1 roping ratio or more, such as a 1:4 roping.

Rollers allow forming a roping, which is very suitable for retracting the movable apron from the extended position to the retracted position. A block and tackle is very well suited for retracting the movable apron from the extended position to the retracted position. A block and tackle may, in particular, be configured for retracting the apron fast enough for preventing the apron from touching the bottom of the hoistway, when the elevator car approaches the bottom of the hoistway.

Additionally or alternatively, the retraction mechanism may comprise a rack and/or a pinion. The rack and the pinion may in particular engage with each other for retracting the movable apron from the extended position into the retracted position. The retraction mechanism may, for example, comprise a drum system, fixed to the car, which will wrap the rope for moving the apron.

An elevator car according to an exemplary embodiment of the invention may comprise two retraction mechanisms. Providing two retraction mechanisms enhances the operational reliability by adding redundancy.

The two retraction mechanisms may be located on two opposite lateral sides of the elevator car. Such an arrangement of the two retraction mechanisms allows for applying symmetric forces to the apron, resulting in a very symmetric movement of the apron. This may in particular reduce the risk of blocking the movement of the apron due to canting.

The apron may be made of a flexible material such as a flexible fabric in order to allow for collapsing the apron when the apron is retracted from the extended position into the retracted position. An apron made of a flexible material may also be expanded again when the apron is moved from the retracted position into the extended position.

The apron may also be a telescopic apron comprising a plurality of telescopic elements which are movable with respect to each other for moving the movable apron between the extended position and the retracted position and vice versa. The telescopic elements may be rigid or flexible.

An elevator system according to an exemplary embodiment of the invention may comprise at least one guide rail. The at least one activation member may be mounted to the at least one guide rail. The at least one activation member may in particular extend or protrude from the at least one guide rail. A guide rail of the elevator system provides a suitable place for mounting and supporting the at least one activation member within the hoistway.

The at least one activation member may include at least one of a roller, a pinion and a rack, configured for interacting with the retraction mechanism formed at the elevator car for activating the retraction of the apron, when the elevator car approaches the bottom of the hoistway.

The at least one activation member may in particular include a roller, which is configured for deflecting an apron tension member, in particular a rope or belt, of the at least retraction mechanism when the elevator car approaches the bottom of the hoistway. The combination of an apron tension member with at least one a roller which is configured for deflecting the apron tension member when the elevator car approaches the bottom of the hoistway provides a very reliable retraction mechanism, which may be implemented at low costs.

A method according to an exemplary embodiment of the invention may include activating the retraction mechanism in the course of downward movement of the elevator car by engaging at least one activation member, which is located within the hoistway, with at least one component of the at least one retraction mechanism provided at the elevator car.

The method may further include extending the apron from its retracted position to its extended position by elevating the elevator car from the bottom of the hoistway.

### BRIEF DESCRIPTION OF THE DRAWINGS

In the following an exemplary embodiment of the invention is described with reference to the enclosed figures.

FIG. 1 schematically depicts an elevator system according to an exemplary embodiment of the invention.

FIGS. 2A and 2B depict enlarged side views of an elevator car in accordance with an exemplary embodiment of the invention, which is located in some distance above the bottom of the hoistway.

FIGS. 3A and 3B depict an enlarged side view of the elevator car depicted in FIGS. 2A and 2B, which is located close to the bottom of the hoistway.

FIGS. 4A and 4B depict enlarged side views of an elevator car in accordance with another exemplary embodiment of the invention, which is located in some distance above the bottom of the hoistway.

FIGS. 5A and 5B depict an enlarged side view of the elevator car depicted in FIGS. 4A and 4B, which is located close to the bottom of the hoistway.

### DETAILED DESCRIPTION OF THE INVENTION

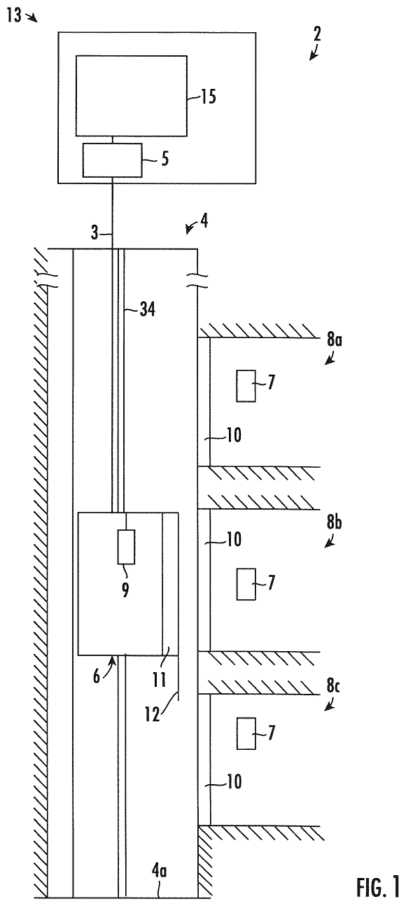

FIG. 1 schematically depicts an elevator system 2 comprising a hoistway 4 extending in a vertical direction between a plurality of landings 8a-8c, which are located on different floors, i.e. at different heights above a bottom 4a of the hoistway 4.

In the exemplary embodiment depicted in FIG. 1, the elevator system 2 comprises three landings 8a-8c. The skilled person understands that an elevator system 2 according to an exemplary embodiment of the invention may also comprise only two landings 8a-8c or more than three landings 8a-8c, respectively.

The elevator system 2 further comprises an elevator car 6, which is movably suspended within the hoistway 4 by means of a car tension member 3. The car tension member 3, for example a rope or belt, is coupled to an elevator drive system 5, comprising a motor and a drive that harnesses and controls the electrical energy sent to the motor. The elevator drive system 5 is configured for driving the car tension member 3 in order to move the elevator car 6 along the longitudinal direction/height of the hoistway 4 between the plurality of landings 8a-8c.

In an alternative embodiment, which is not depicted in the figures, the elevator system 2 may be an elevator system 2 without a car tension member 3, comprising e.g. a hydraulic drive system, or a drive system comprising a linear motor.

The exemplary embodiment of the elevator system 2 shown in FIG. 1 employs a 1:1 roping for suspending the elevator car 6. The skilled person, however, easily understands that the type of the roping is not essential for the invention and that different kinds of roping, e.g. a 2:1 roping, may be used as well.

Optionally, the elevator system 2 may further include a counterweight, which is not shown in FIG. 1, moving concurrently and in opposite direction with respect to the elevator car 6. Alternatively, the elevator system 2 may be an elevator system 2 without a counterweight, as it is depicted in FIG. 1.

The elevator system 2 may comprise at least one guide rail 34 for guiding the movement of the elevator car 6 along the hoistway 4.

Each landing 8a-8c is provided with at least one landing door 10, which also may be denoted as elevator hoistway door. The elevator car 6 is provided with at least one corresponding elevator car door 11 allowing passengers to transfer between a landing 8a-8c and the interior space of the elevator car 6, when the elevator car 6 is positioned at the respective landing 8a-8c.

For moving the elevator car 6 along the hoistway 4 between the different landings 8a-8c, the elevator drive system 5 is controlled by a controller 15 of the elevator system 2.

The elevator system 2 may have a machine room 13 housing the elevator drive system 5 and the controller 15. Alternatively, the elevator system 2 may be a machine room-less elevator system 2.

Input to the controller 15 may be provided via landing devices 7, which are provided at the landings 8a-8c in the vicinity of the elevator landing doors 10, and/or via an elevator car control device 9, which is provided inside the elevator car 6.

The elevator car 6 is equipped with an apron 12 extending from the bottom of the elevator car 6.

The apron 12 closes a gap, which may be formed between the bottom of the elevator car 6 and one of the landings 8a-8c, when the elevator car 6 is located in some distance above the respective landing 8a-8c.

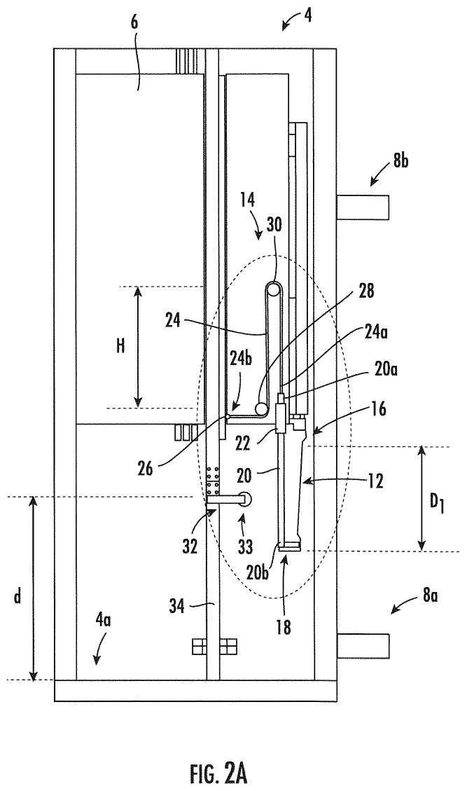

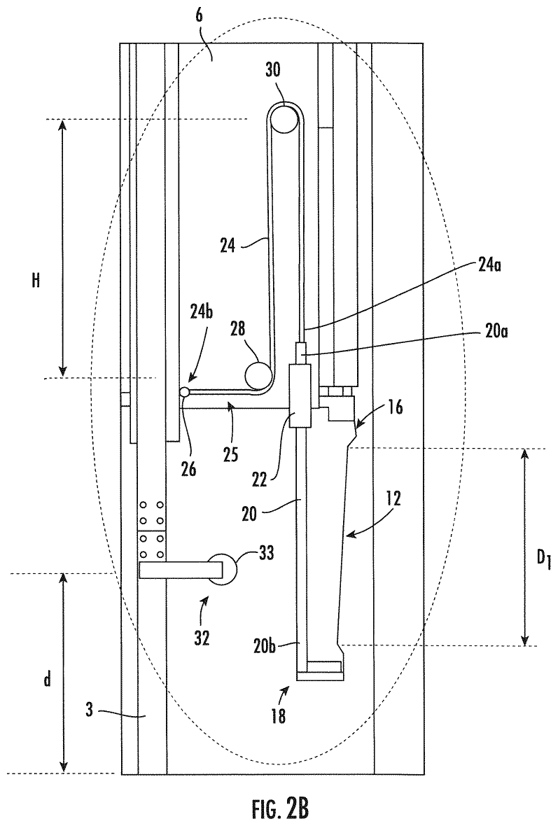

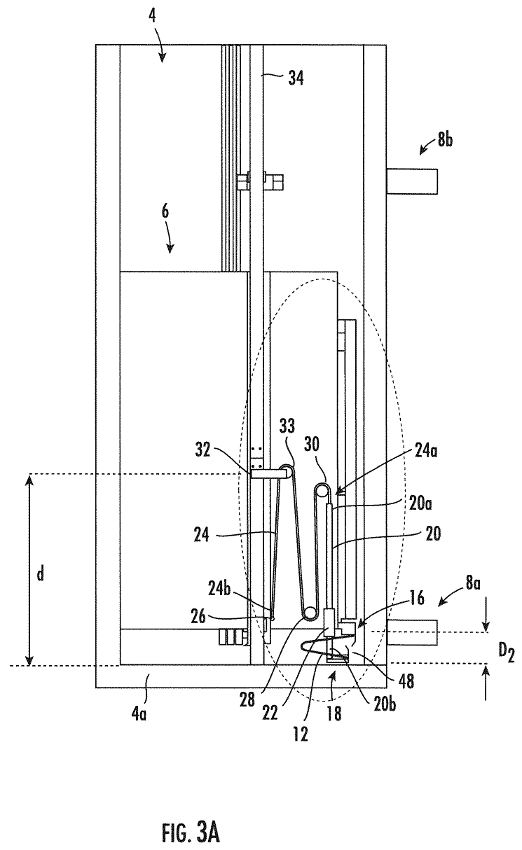

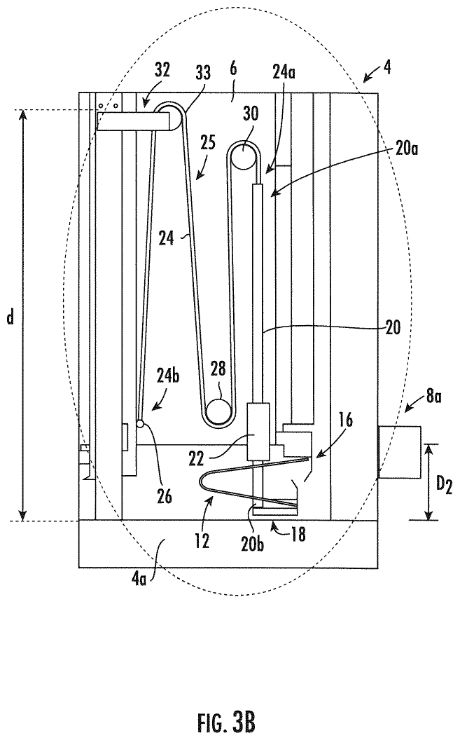

FIGS. 2A, 2B, 3A and 3B show enlarged detailed side views of an elevator car 6 in accordance with an exemplary embodiment of the invention.

In FIGS. 2A and 2B, the elevator car 6 is located in some distance above the bottom 4a of the hoistway 4. In FIGS. 3A and 3B, the elevator car 6 is located at the lowermost landing 8a close to the bottom 4a of the hoistway 4.

In an elevator car 6 according to an exemplary embodiment of the invention, the apron 12 is movable between an extended position, as it is depicted in FIGS. 2A and 2B, and a retracted position, as it is depicted in FIGS. 3A and 3B.

In the extended position depicted in FIGS. 2A and 2B, the apron 12 extends over a first distance D1 from a bottom of the elevator car 6. In the retracted position, the apron 12 extends over a second distance D2 from the bottom of the elevator car 6, wherein the second distance D2 is shorter than the first distance D1.

Retracting the apron 12 from the extended position into the retracted position, as it is depicted in FIGS. 3A and 3B, allows moving the elevator car 6 close to the bottom 4a of the hoistway 4. According to exemplary embodiments of the invention, the apron 12 may be retracted without causing mechanical contact between the apron 12 and the bottom 4a of the hoistway 4.

Particularly, according to exemplary embodiments of the invention, the elevator car 6 comprises a retraction mechanism 14, which is configured for automatically retracting the apron 12 from the extended position to the retracted position when the elevator car 6 approaches the bottom 4a of the hoistway 4.

An exemplary embodiment of such a retraction mechanism 14 formed on a lateral side of the elevator car 6 is depicted in FIGS. 2A, 2B, 3A and 3B.

A second, similar retraction mechanism 14 may be formed on the opposite lateral side of the elevator car 6, which is not visible in FIGS. 2A, 2B, 3A and 3B. In an embodiment comprising two retraction mechanisms 14, the apron 12 may extend between the two retraction mechanisms 14 in the horizontal direction in order to be moved symmetrically by the two retraction mechanisms 14 between the extended position and the retracted position.

As it is depicted in FIGS. 2A, 2B, 3A and 3B, the apron 12 may be a flexible apron 12, i.e. an apron 12 that is made of a flexible material, such as a flexible fabric.

In an alternative embodiment, which is not shown explicitly in the figures, the apron 12 may be a telescopic apron 12, comprising a plurality of telescopic elements, which are telescopically movable with respect to each other for varying the height of the apron 12 along the longitudinal direction.

In yet another embodiment, which is also not explicitly shown in the figures, the apron 12 may be a rigid apron 12, which is pivotable between the extended position and the retracted position.

In the embodiment depicted in FIGS. 2A, 2B, 3A and 3B, an upper end of the apron 12 is fixed to a stationary apron holder 16 provided at the bottom of the elevator car 6.

An opposite lower end of the apron 12 is fixed to a movable apron holder 18, which is arranged in some vertical distance below the upper apron holder 16. In other words, the apron 12 extends between the stationary apron holder 16 and the movable apron holder 18, and the height of the apron 12 along the vertical direction is variable by varying the distance between the stationary apron holder 16 and the movable apron holder 18.

The movable apron holder 18 is supported by a movable support 20, for example by a rod, extending in the vertical direction. The movable support 20 is movably supported by the elevator car 6. The movable support 20 may, for example, extend through a sleeve 22 formed at the side of the elevator car 6, which allows the movable support 20 to move with respect to the elevator car 6 in the vertical direction.

The movable support 20, in particular an upper end 20a of the movable support 20, which is opposite to the movable apron holder 18 provided at a lower end 20b of the movable support 20, is coupled to a first end 24a of a flexible apron tension member 24. The flexible apron tension member 24 may be a rope or belt. The flexible apron tension member 24 may in particular be a wire rope made of steel or a rope or belt made of a suitable synthetic material.

As a result, the apron 12 is movable from its extended position depicted in FIGS. 2A and 2B to its retracted position depicted in FIGS. 3A and 3B by pulling the apron tension member 24 upwards, thereby pulling upwards the movable apron holder 18 as well.

A second, opposite end 24b of the apron tension member 24 is fixed to an apron tension member fixture 26 formed at the elevator car 6.

Two rollers 28, 30 are provided on the side of the elevator car 6 for deflecting the apron tension member 24 along its path between the apron tension member fixture 26 and the upper end 20a of the movable support 20.

In the embodiment depicted in FIGS. 2A, 2B, 3A and 3B, a first roller 28 of the two rollers 28, 30 is arranged at approximately the same height as the apron tension member fixture 26. As a result, a portion 25 of the apron tension member 24 extends basically horizontally between the apron tension member fixture 26 and the first roller 28, when the apron 12 is in the extended position, as it is depicted in FIGS. 2A and 2B.

It is noted that the first roller 28 may be arranged somewhat above or below the height of the apron tension member fixture 26 causing the portion 25 of the apron tension member 24 to extend in an inclined direction.

The second roller 30 is arranged in some height above the first roller 28. The apron tension member 24 extends around the first and second rollers 28, 30 so that the path of the apron tension member 24 between the first roller 28 and the upper end 20a of the movable support 20 has the shape of an inverse “U” or “V”, i.e. the shape of a “U” or “V”, which is oriented in an upside-down orientation.

Other configurations of the rollers 28, 30 are possible as well. Exemplary embodiments of a retraction mechanism 14 according exemplary embodiments of the invention may, in particular, include configurations comprising more than two rollers 28, 30.

The rollers 28, 30 may be pulleys, drums, or barrels.

For activating the retraction mechanism 14 when the elevator car 6 approaches the bottom 4a of the hoistway 4, an activation member 32 is provided within the hoistway 4. The activation member 32 may be mounted to and extend from a guide rail 34 of the elevator system 2.

The activation member 32 is in particular arranged at a predefined constant distance or height d from the bottom 4a of the hoistway 4. The activation member 32 does not move with the elevator car 6, but is stationary with respect to the hoistway 4.

The activation member 32 may comprise an activation roller 33, which is configured for engaging with the apron tension member 24, when the elevator car 6 approaches the bottom 4a of the hoistway 4, as it is depicted in FIGS. 3A and 3B.

The activation roller 33 may be a pulley, a drum, or a barrel.

The activation roller 33 of the activation member 32 may in particular be configured for engaging with the portion 25 of the apron tension member 24 that extends basically horizontally between the apron tension member fixture 26 and the first roller 28 when the apron tension member 24 is not engaged with the activation member 32.

In consequence of said engagement, the horizontal portion 25 of the apron tension member 24 is deformed into the shape of a second inverse “U” or “V”, when the elevator car 6 is lowered within the hoistway 4 so that the horizontal portion 25 of the apron tension member 24 is lowered below the activation member 32.

As a result of forming the second inverse “U” or “V”, the first end 24a of the apron tension member 24, which is fixed to the movable support 20, is pulled upwards with respect to the elevator car 6, when the elevator car 6 approaches the bottom 4a of the hoistway 4. In consequence, the movable support 20 and the movable apron holder 18 are pulled up as well, thereby retracting the apron 12 from its extended position depicted in FIGS. 2A and 2B into its retracted position depicted in FIGS. 3A and 3B.

The dimensions of the movable support 20 and the apron tension member 24 as well as the position/height d of the activation member 32 within the hoistway 4 are set so that the apron 12 is retracted before and without touching the bottom 4a of the hoistway 4.

In consequence, noise and wear of the apron 12, which could be caused by any mechanical contact between the apron 12 and the bottom 4a of the hoistway 4, may be reliably prevented.

When the elevator car 6 is moved upwards, away from the bottom 4a of the hoistway 4, the first and second rollers 28, 30, which are fixed to the elevator car 6, move upwards with respect to the activation member 32 as well. In consequence, the lengths of the legs of the second inverse “U” or “V” formed by the portion 25 of the activation member 32 between the apron tension member fixture 26 and the first roller 28 are reduced as well. This allows the movable support 20 and the movable apron holder 18 to move downwards with respect to the elevator car 6 under their own weight, thereby extending the apron 12 from its retracted position into its extended position, as it is depicted in FIGS. 2A and 2B.

Optionally, additional weight may be added to the movable support 20 and/or to the movable apron holder 18 for increasing the reliability of the movement of the apron 12 from its retracted position into its extended position.

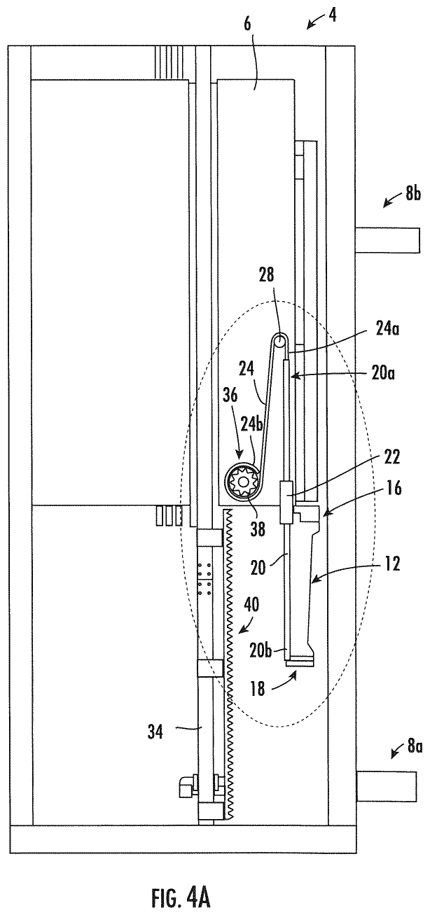

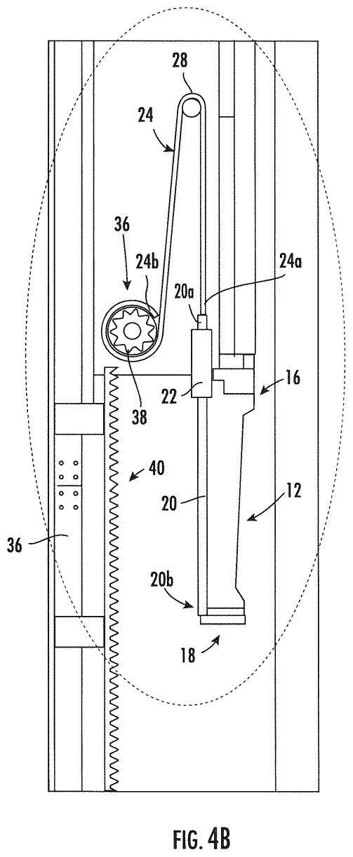

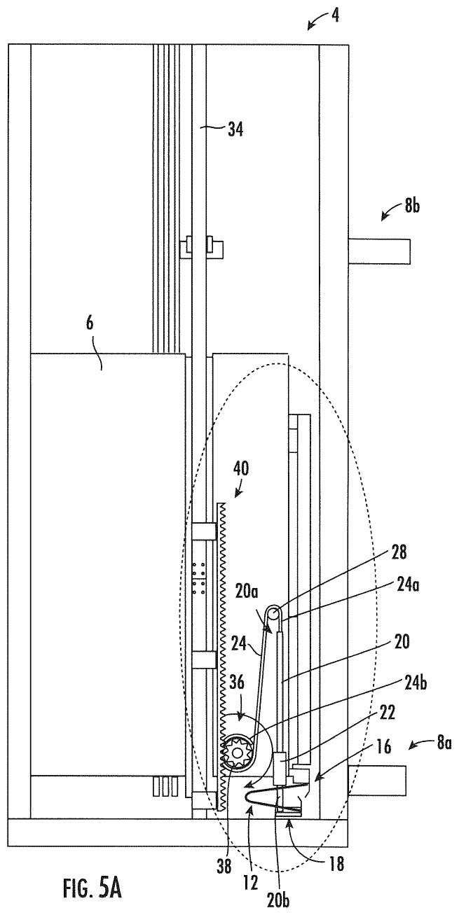

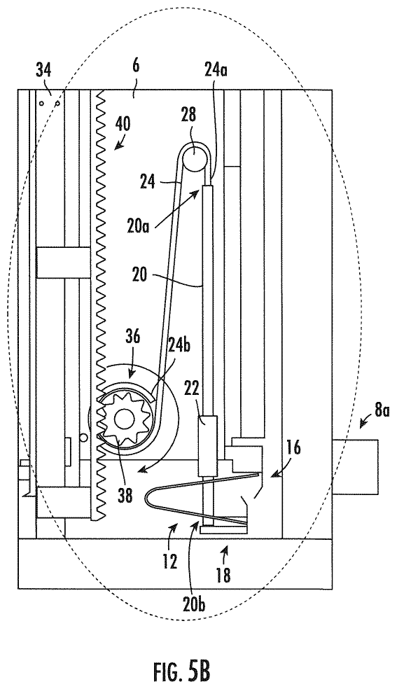

FIGS. 4A, 4B, 5A and 5B show enlarged detailed side views of an elevator car 6 in accordance with another exemplary embodiment of the invention.

In FIGS. 4A and 4B, the elevator car 6 is located in some distance above the bottom 4a of the hoistway 4. In FIGS. 5A and 5B, the elevator car 6 is located at the lowermost landing 8a close to the bottom 4a of the hoistway 4.

The features, which correspond to the features of the embodiment depicted in FIGS. 2A, 2B, 3A and 3B are denoted with the same reference signs and will not be discussed in detail again. The detailed description of these features with reference to FIGS. 2A, 2B, 3A and 3B provided above correspondingly applies to the features of the embodiments depicted in FIGS. 4A, 4B, 5A and 5B.

Contrary to the embodiment depicted in FIGS. 2A, 2B, 3A and 3B, the retraction system 14 provided at the elevator car 6 depicted in FIGS. 4A, 4B, 5A and 5B comprises only a single roller 28. Further embodiments of the retraction system 14 may comprise two or more rollers 28 for guiding the apron tension member 24.

Further, contrary to the embodiment depicted in FIGS. 2A, 2B, 3A and 3B, the second end 24b of the apron tension member 24 is not fixed to a stationary apron tension member fixture 26 at the elevator car 6. Instead, the second end 24b of the apron tension member 24 is attached to a rotatable drum 36, which is mounted to the elevator car 6, and which is configured for winding up the apron tension member 24, when it is rotated.

As illustrated in FIGS. 5A and 5B, winding up the apron tension member 24 onto the drum 36 by rotating the drum 36 pulls the first end 24a of the apron tension member 24 upwards, thereby pulling the movable apron holder 18 upwards as well.

A pinion 38 is coupled with one end of the drum 36 so that the drum 36 is rotatable by rotating the pinion 38. The pinion 38 is in particular arranged coaxially with the drum 36. The pinion 38 may be attached to the drum 36. Alternatively, the pinion 38 may be formed integrally with the drum 36.

In an alternative embodiment, which is not explicitly depicted in the figures, the pinion 38 may be provided separately from the drum 36, in particularly at a position, which is offset from the axis of the drum 36. In such an embodiment, the drum 36 and the pinion 38 may be mechanically coupled by a coupling element, such as a chain or a belt, causing the drum 36 and the pinion 38 to rotate concurrently with each other. Optionally, the coupling element may further include a gear, i.e. a plurality of pinions, which are pairwise in engagement with each other.

A toothed rack 40 extending in a vertical direction parallel to the guide rail 34 is provided in a lower portion of the hoistway 4 close to the bottom 4a of the hoistway 4. The toothed rack 40 may, in particular, be supported by the guide rail 34.

When the elevator car 6 approaches the bottom 4a of the hoistway 4, the pinion 38 engages with the toothed rack 40, as it is depicted in FIGS. 5A and 5B.

When the pinion 38 is engaged with the toothed rack 40, downward movement of the elevator car 6 causes the pinion 38 and the drum 36 to rotate in the clockwise direction, as illustrated in FIGS. 5A and 5B. As a result of this rotation of the drum 38, the apron tension member 24 is wound up on the drum 36. This pulls the movable apron holder 18 up with respect to the elevator car 6, retracting the apron 12, as it is depicted in FIGS. 5A and 5B.

Thus, the movable apron holder 18 moves upwards automatically with respect to the elevator car 6, when the elevator car 6 approaches the bottom 4a of the hoistway 4. As a result, the apron 12 is retracted automatically, and the apron 12 may be reliably prevented from hitting the bottom 4a of the hoistway 4.

When the elevator car 6 moves upwards, away from the bottom 4a of the hoistway 4, the engagement between the pinion 38 and the toothed rack 40 causes the pinion 38 and the drum 36 to rotate in the opposite (counterclockwise) direction, thereby causing the apron tension member 24 to unwind from the drum 36.

Unwinding the apron tension member 24 from the drum 36 allows the movable apron holder 18, driven by its own weight and the weight of the apron 12, to move downwards with respect to the elevator car 6, thereby unfolding the apron 12 from its retracted position into its extended position, as depicted in FIGS. 4A and 4B.

The dimensions of the toothed rack 40, the pinion 38, the drum 36, the apron tension member 24, the movable support 18 and the apron 12 are set so that the pinion 38 reaches the upper end of the toothed rack 40 and disengages from the toothed rack 40, when the apron 12 is fully extended.

The elevator car 6 may then continue to move upwards towards the upper end of the hoistway 4 with the apron 12 being fully extended.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention is not limited to the particular embodiments disclosed, but that the invention includes all embodiments falling within the scope of the claims.

What is claimed is:

1. An elevator car (6) comprising:
a retractable apron (12), which is movable between an extended position and a retracted position; and
a retraction mechanism (14), which is configured for retracting the apron (12) from the extended position to the retracted position when the elevator car (6) approaches the bottom (4a) of a hoistway (4), so that the apron (12) does not contact the bottom (4a) of the hoistway (4).

2. The elevator car (6) according to claim 1, wherein the retraction mechanism (14) is a completely mechanical mechanism, which does, in particular, not comprise any electric components.

3. The elevator car (6) according to claim 1, wherein the retraction mechanism (14) comprises an apron tension member (24), in particular a rope or belt, which is coupled to the apron (12) for moving the apron (12) from the extended position to the retracted position, wherein the apron tension member (24) comprises in particular a first end (24a), which is coupled to the apron (12), and a second end (24b), which is coupled to the elevator car (6) or any activation system provided at the elevator car (6).

4. The elevator car (6) according to claim 3, wherein the retraction mechanism (14) comprises at least one roller (28, 30), which is supported by the elevator car (6), for deflecting the apron tension member (24), wherein the retraction mechanism (14) comprises in particular two rollers (28, 30) or three rollers (28, 30), supported by the elevator car (6).

5. The elevator car (6) according to claim 4, wherein the at least one roller (28, 30) and the apron tension member (24) are arranged in a configuration to form a block and tackle, in particular a block and tackle with a 1:2 roping, when the elevator car (6) is mounted in a hoistway (4).

6. The elevator car (6) according to claim 1, wherein the retraction mechanism (14) comprises a rack and/or a pinion.

7. The elevator car (6) according to claim 1, comprising two retraction mechanisms (14), wherein the two retraction mechanisms (14) are in particular provided on two opposite lateral sides of the elevator car (6).

8. The elevator car (6) according to claim 1, wherein the apron (12) is made of a flexible material and/or wherein the apron (12) is a telescopic apron (12).

9. An elevator system (2) comprising:
a hoistway (4) having a bottom (4a) and extending between a plurality of landings (8a-8c);
an elevator car (6) according to claim 1, which is configured for traveling along the hoistway (4) between the plurality of landings (8a-8c); and
at least one activation member (32) provided in the hoistway (4);
wherein the at least one activation member (32) is configured for interacting with the at least one retraction mechanism (14) of the elevator car (6) for causing the at least one retraction mechanism (14) to retract the apron (12) so that the apron (12) does not contact the bottom (4a) of the hoistway (4), when the elevator car (6) approaches the bottom (4a) of the hoistway (4).

10. The elevator system (2) according to claim 9, comprising at least one guide rail (34), wherein the at least one activation member (32) is mounted to the at least one guide rail (34), wherein the at least one activation member (32) extends in particular from the at least one guide rail (34).

11. The elevator system (2) according to claim 9,
wherein the at least one activation member (32) includes at least one of a roller (33), a pinion and a rack;
wherein the at least one activation member (32) includes in particular at least one roller (33), which is configured for deflecting an apron tension member (24), in particular a rope or belt, of the the at least retraction mechanism (14), when the elevator car (6) approaches the bottom (4a) of the hoistway (4).

12. A method of moving the apron (12) of the elevator car (6) in an elevator system (2) according to claim 9, wherein the method includes:
activating the at least one retraction mechanism (14) of the elevator car (6) in the course of moving the elevator car (6) towards the bottom (4a) of the hoistway (4) such as to move the apron (12) from the extended position to the retracted position, thereby preventing the apron (12) from contacting the bottom (4a) of the hoistway (4).

13. The method according to claim 12, wherein the method includes activating the at least one retraction mechanism (14) of the elevator car (6) by engaging at least one activation member (32) located within the hoistway (4) with at least one component of the at least one retraction mechanism (14).

14. The method according to claim 12, wherein the method includes extending the apron (12) from its retracted position into its extended position in the course of elevating the elevator car (6) from the bottom of the hoistway (4).
